(19) United States
(12) Patent Application Publication
(10) Pub. No.: US 2008/0020272 A1
(43) Pub. Date: Jan. 24, 2008

(54) DEVICE AND METHOD FOR PRODUCING LAYERED BATTERY CELLS

(76) Inventor: Paul Leslie Kemper, Frankton, IN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/782,309

(22) Filed: Jul. 24, 2007

Related U.S. Application Data
(60) Provisional application No. 60/820,146, filed on Jul. 24, 2006.

(51) Int. Cl. H01M 2/00; H01M 6/00

(52) U.S. Cl. 429/163; 29/730; 901/14; 901/30

(57) ABSTRACT

A device of the present invention is used for forming a layered battery cell having at least first electrode and at least one second electrode of charge opposite from said first electrode and a separator layer positioned between the first and second electrodes and at least one of a first current collector connected to at least one of the first and second electrodes and at least one of a second current collector connected to at least one of the first and second electrodes. At least one support member is integrated with an assembly line. A plurality of pins extend from the support member for receiving the first and second electrodes and the first and second current collectors layered with one another to assemble the same into a unitary package.

### RELATED APPLICATIONS

This non-provisional application claims priority to a provisional application Ser. No. 60/820,146 filed on Jul. 24, 2006 and incorporated herewith by reference in its entirety.

### BACKGROUND OF THE INVENTION

The subject invention relates to battery cells, and more specifically to a device for and a method of producing multi-layered battery cells.

### BACKGROUND OF THE INVENTION

Motor vehicles, such as, for example, hybrid vehicles use multiple propulsion systems to provide motive power. This most commonly refers to gasoline-electric hybrid vehicles, which use gasoline (petrol) to power internal-combustion engines (ICEs), and electric batteries to power electric motors. These hybrid vehicles recharge their batteries by capturing kinetic energy via regenerative braking. When cruising or idling, some of the output of the combustion engine is fed to a generator (merely the electric motor(s) running in generator mode), which produces electricity to charge the batteries. This contrasts with all-electric cars which use batteries charged by an external source such as the grid, or a range extending trailer. Nearly all hybrid vehicles still require gasoline as their sole fuel source though diesel and other fuels such as ethanol or plant based oils have also seen occasional use.

Batteries and cells are important energy storage devices well known in the art. The batteries and cells typically comprise electrodes and an ion conducting electrolyte positioned therebetween. Lithium batteries are proven to be an attractive energy storage device and have been targeted for various applications such as portable electronics, cellular phones, power tools, electric vehicles, and load-leveling/peak-shaving. The art is replete with various modifications of lithium batteries taught by the U.S. Pat. No. 5,961,672, as related to a stabilized anode for lithium polymer batteries; U.S. Pat. No. 5,952,126 as pertaining to polymer solid electrolyte and lithium secondary cells. Other variations on lithium batteries are described in the U.S. Pat. Nos. 5,853,914 and 5,773,959.

Typically, the individual cells of the battery pack are placed over studs at every other cell position on the tray. An electrically conductive disk is then placed over each stud until resting on each cell contact surface. The remaining cells are then placed over the studs in the un-occupied positions of the tray, overlapping the previously placed cells. The nut is applied to each stud and is torqued to apply communications from an electrical string of battery cells to a remote electronic controller. It is important to align electrodes, such as cathodes and anodes as the cells are assembled to avoid inconsistent alignment between the electrodes, shifting of the electrodes and bus tabs during handling and assembly, thereby improving energy efficiency.

Other prior art designs of the lithium polymer batteries suffered from the inconsistent alignment from cell to cell, shifting of cells during handling, and poor energy efficiency. The U.S. Pat. No. 6,242,128 tried to solve the problem of aligning the tab bussings by a fixture frame having plurality of alignment pins used for alignment of the anode and cathode tabs before the tab bussing structure is formed. However, there is a constant need in the area of the battery art for an improved design of devices for and a method of producing multi-layered battery cells.

### SUMMARY OF THE INVENTION

In one aspect of the present invention, an alignment device includes a body having a recess on each of the longitudinal sides and multiple ejector bores extending therethrough adjacent alignment bores. The alignment bores include a shank portion and a head portion, with the head portion located adjacent a bottom surface of the body and defining a diameter greater in size than a diameter defined by the shank portion, with the shank portion of the alignment bores extending from the head portion to a top surface of the body. A plurality of alignment pins are disposed within each of the alignment bores and include a head located within the head portion of the alignment bore.

A support of the device includes a generally rectangular shape having a pair of laterally space longitudinal sides and a pair of laterally spaced end walls. The support defines a recess in each of the longitudinal sides of the support, identical in size and shape and disposed adjacent the recesses defined by the longitudinal sides of the body.

A cover plate of the device includes a generally rectangular shape having a pair of laterally spaced longitudinal sides and a pair of laterally spaced end walls. The cover plate also defines a recess in each of the longitudinal sides identical in size and shape and disposed over the recesses defined by the body and the support. The cover plate defines at least two alignment bores concentric with the alignment bores defined by the body. The alignment bores are defined by the cover plate and include a diameter equal to the diameter of the shank portion of the alignment bore defined by the body. The cover plate further defines a fastener passage corresponding to each of the ejector bores defined by the body and the support.

An ejector shaft is disposed in each of the ejector bores, and extends from a bottom surface of the cover plate to near a bottom surface of the support. A fastener, such as a screw, is disposed within each of the fastener passages and is in threaded engagement with the ejector shaft, thereby connecting the ejector shafts to the cover plate.

In another aspect of the present invention, a battery assembly of the present invention is adaptable to be utilized in various configurations including and not limited to an overlapping battery cell packaging configuration and a vertical stack battery cell packaging configuration. The battery assembly includes a first cell and a second cell adjacent the first cell. A cell for a battery pack has a first electrode adjacent a first current collector and a second electrode of charge opposite from the first electrode and adjacent a second current collector. A separator layer is positioned between the first and second electrodes. The first and second electrodes conduct electrolyte therebetween. A first insulator extends over the first electrode and a second insulator extends over the second electrode.

An envelope has an upper wall and a lower wall defining a pocket therebetween and extending over the first and second insulators thereby encapsulating the first and second insulators. The envelope terminates into a negative terminal and a positive terminal opposed the negative terminal. The positive and negative terminals define at least one contact with each of the negative and positive terminals defining a pair of openings transversely extending through the upper and lower walls of the envelope. A conductor device or electrically-conductive disk is formed from a copper is disposed between the upper and lower walls at the positive and negative terminals. The conductor device extends through each of the openings to define a boss around and above each of the openings.

An advantage of the present invention is to provide an alignment device to align electrodes, such as cathodes and anodes, of the cell as the cells are assembled to avoid inconsistent alignment between the electrodes, shifting of the electrodes and bus tabs during handling and assembly, thereby improving energy efficiency.

Another advantage of the present invention is to provide a battery cell having a conductor or an electrically-conductive device mechanically engaged therein which provides improved surface-to-surface contact with the electrically-conductive disk of adjacent cell thereby improving the electrically conductive characteristics of the battery cells as the individual battery cells are placed over the studs at every other cell position to form a battery pack.

Still another advantage of the present invention is to provide a battery cell that reduces manufacturing costs due to simplified assembly pattern.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded end view of a battery cell showing several component layers of the battery cell and a pair of bussing tabs;

FIG. 2 is a cross sectional side view of an alignment device of the present invention;

FIG. 3 is a cross sectional view of the alignment device of FIG. 2 with multiple electrodes of the battery cell layered on the alignment device;

FIG. 4 is a top view of the alignment device;

FIG. 5 is a top view of a body of the alignment device;

FIG. 6 is a cross sectional side view of the body;

FIG. 7 is a top view of a support of the alignment device;

FIG. 8 is a cross sectional view of the support;

FIG. 9 is a top view of a cover plate of the alignment device;

FIG. 10 is a cross sectional view of the cover plate;

FIG. 11 is a perspective view of an inventive conductor device defined by a tubular member having a radial lip integral with and extending outwardly from the tubular member;

FIG. 12 is a perspective view of the conductor device of FIG. 1 having folded terminal ends presenting a contact portion;

FIG. 13 is a cross sectional view of a battery cell having a pair of insulators disposed therein and extending through the openings defined in the battery cell and the conductor device disposed between the insulators and extending outwardly and transversely through the openings with the conductor device being folded over the insulators to form a contact surface;

FIG. 14 is a cross sectional view of the pair of battery cell of FIG. 13 with the battery cells being interconnected by a pin; and

FIG. 15 is an exploded view of the alignment device of FIG. 2.

### DETAILED DESCRIPTION OF THE PREFERRED EMBODIMENT

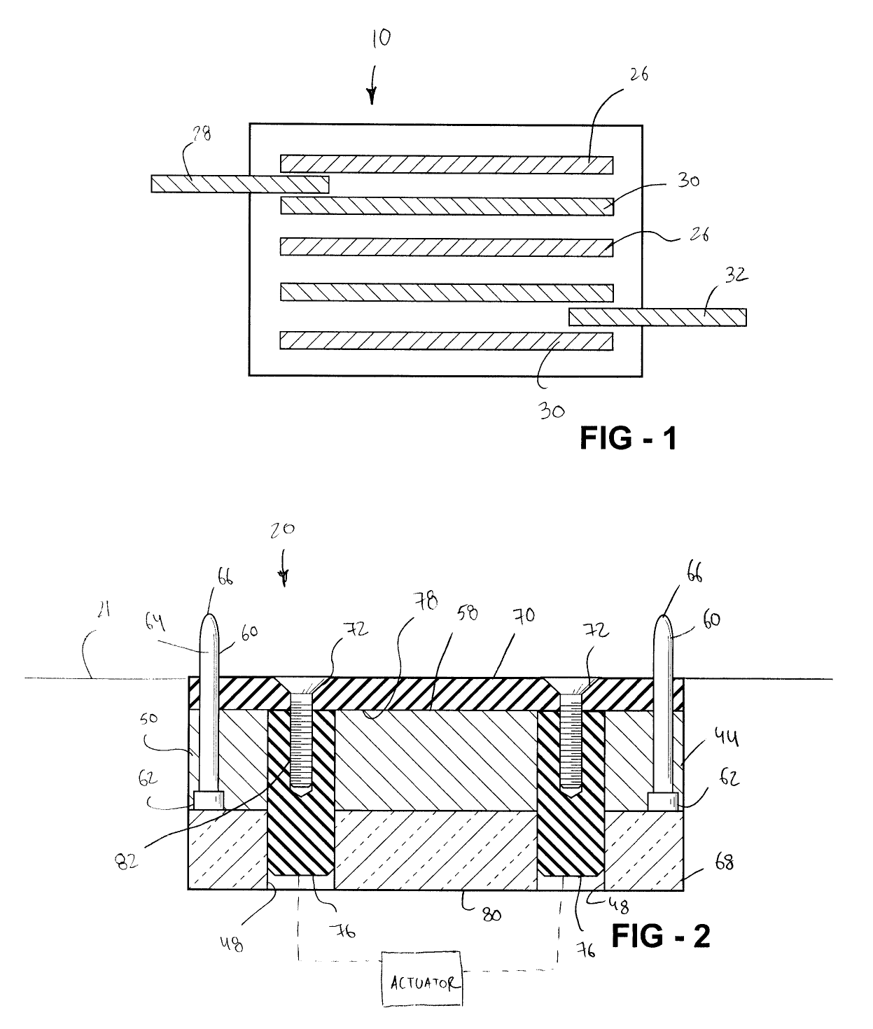

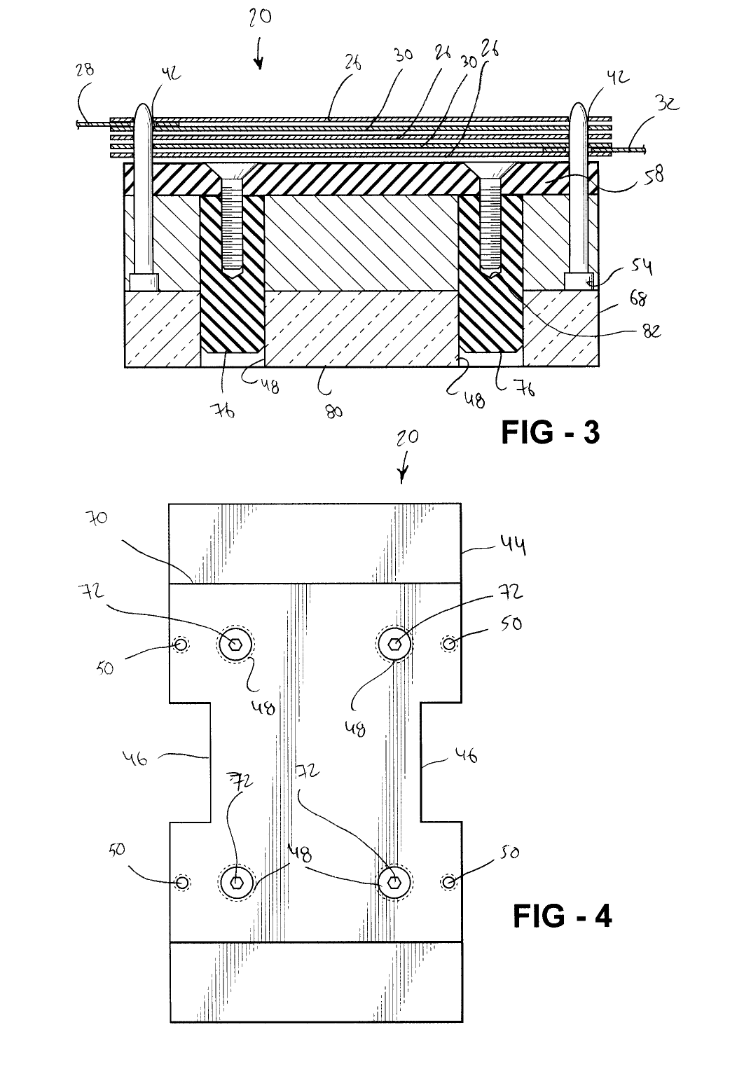

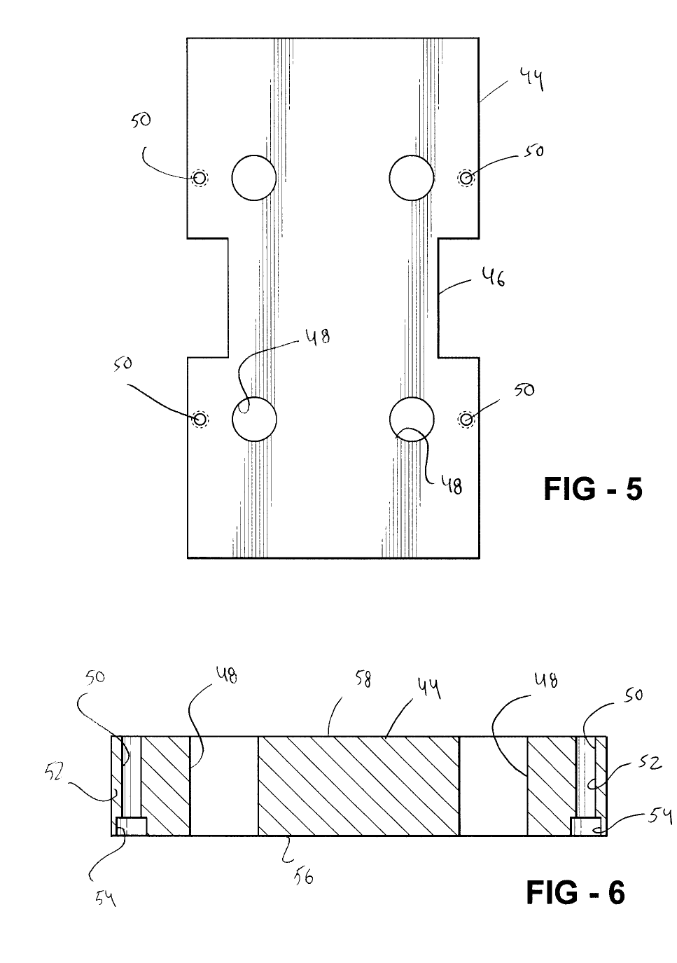

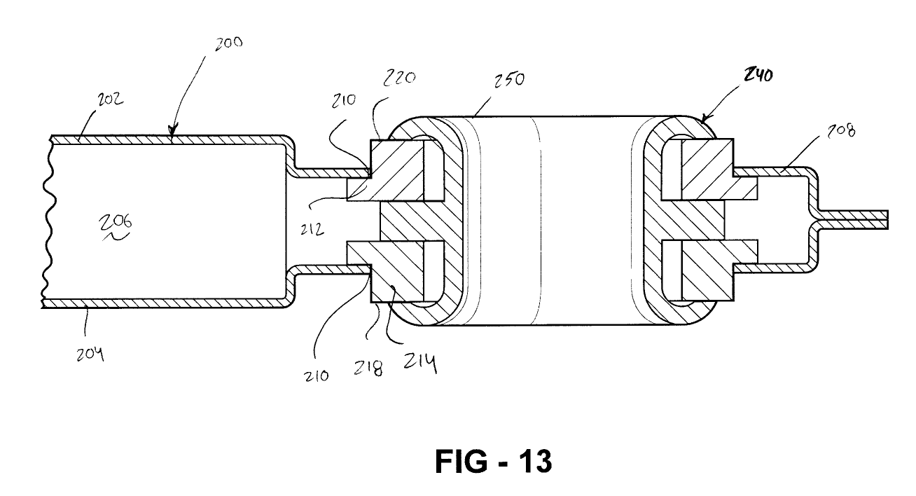

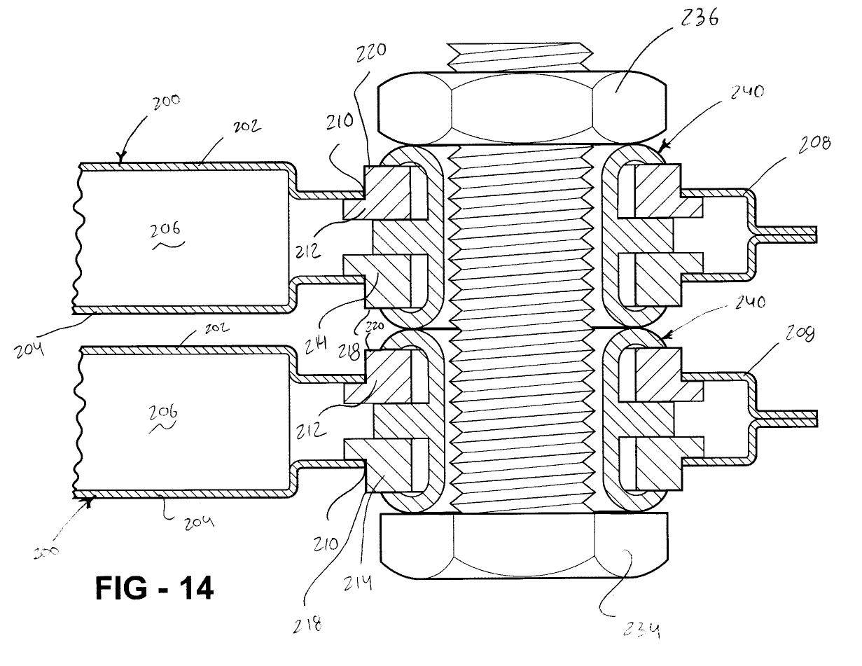

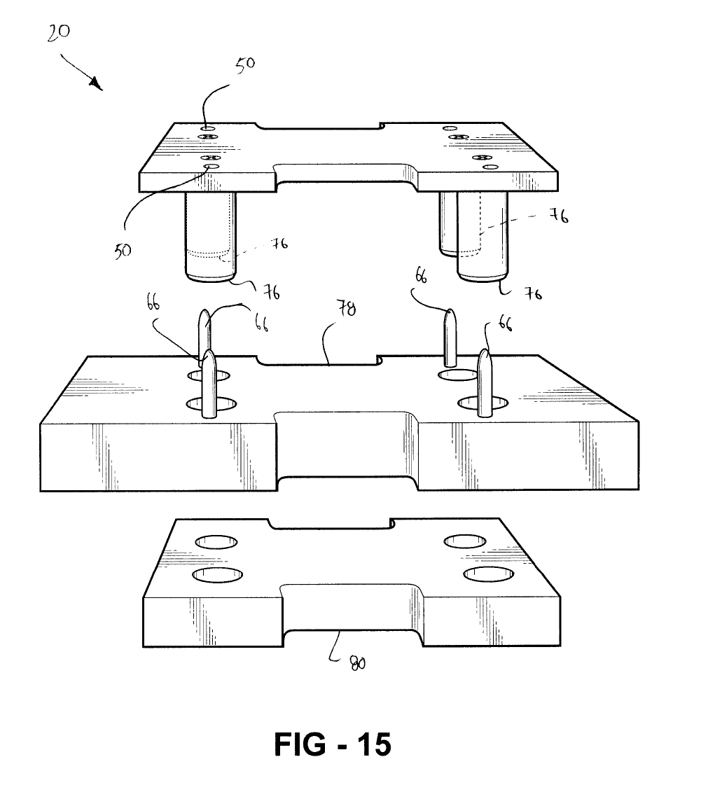

Referring to the FIGS., wherein like numerals indicate like or corresponding parts, a battery cell, generally shown at 10 in FIGS. 13 and 14 is assembled by an alignment device of the present invention, which is generally shown at 20 in FIGS. 2 and 3. The alignment device 20 is an integrated part of an assembly line 21, defined by a conveyor without limiting the scope of the present invention. FIG. 15 shows an exploded view of the alignment device 20 of FIGS. 2 and 3. Referring to FIG. 1, the multi-layered battery cell 10 comprises several component layers 24, sandwiched together to define the battery cell 10, as is well known in the battery art. The several component layers include a first electrode 26 adjacent a first current collector 28, and a second electrode 30 adjacent a second current collector 32. The first electrode 26 and the second electrode 30 are oppositely charged, i.e., one is positively charged and the other is negatively charged. The first electrodes 26, the first current collectors 28, the second electrodes 30, and the second current collectors 32 are moved by the assembly line 21 and are placed thereupon in a predetermined fashion by a multi-axial robotic device. The battery cell 10 of the present invention is adaptable to be utilized in various configurations including and not limited to an overlapping battery cell packaging configuration and a vertical stack battery cell packaging configuration used in an automotive vehicle applications.

A separator layer (not shown) is disposed between the first electrode 26 and the second electrode 30, with the first electrode 26 and the second electrode 30 conducting an electrolyte therebetween. A first insulator (not shown) and a second insulator (not shown) are disposed on opposite sides of the first electrode 26 and the second electrode 30 to sandwich the first electrode 26, the separator layer 34, and the second electrode 30 between the first insulator and the second insulator.

An envelope extends around the periphery of the first insulator and the second insulator and encapsulates the several component layers 24 of the battery cell 10 in a protective covering. The envelope terminates into a positive terminal and a negative terminal opposite the positive terminal as is known in the art. As best shown in FIG. 3, each of the several component layers 24 include at least two alignment apertures 42, located near the periphery of the several component layers 24 and concentric with the alignment apertures 42 defined by the several component layers 24 disposed above and below, i.e., the several component layers 24 cooperate together to define at least two concentric alignment apertures 42 extending through the several component layers 24 as a whole.

As shown in the FIG. 3, each of the several component layers 24 include four alignment apertures 42, located near the corners of each of the several rectangular shaped component layers 24. The alignment device 20 aligns the several different component layers 24 of the multi-layered battery cell 10 during production. The alignment device 20 includes a body 44. The body 44 is generally rectangular shaped having a pair of laterally spaced longitudinal sides and a pair of laterally spaced end walls. The body 44 further includes a recess 46 on each of the longitudinal sides. The body 44 defines at least one ejector bore 48 extending therethrough.

As shown in the Figures, the body 44 defines four ejector bores 48 therethrough. The body 44 further defines at least two alignment bores 50. Preferably, and as shown in the Figures, the body 44 defines four alignment bores 50. The alignment bores 50 include a shank portion 52 and a head portion 54, with the head portion 54 located adjacent a bottom surface of the body 56 and defining a diameter greater in size than a diameter defined by the shank portion 52, with the shank portion 52 of the alignment bores 50 extending from the head portion 54 to a top surface of the body 58.

Referring to FIGS. 2 and 3, an alignment pin 60 is disposed within each of the alignment bores 50 defined by the body 44. The alignment pins 60 each include a head 62 located within the head portion 54 of the alignment bore 50, and a shank 64 located within the shank portion 52 of the alignment bore 50 and extending above the top surface of the body 58. The alignment pin 60 extends from the heat to a distal end 66 having a generally conical point.

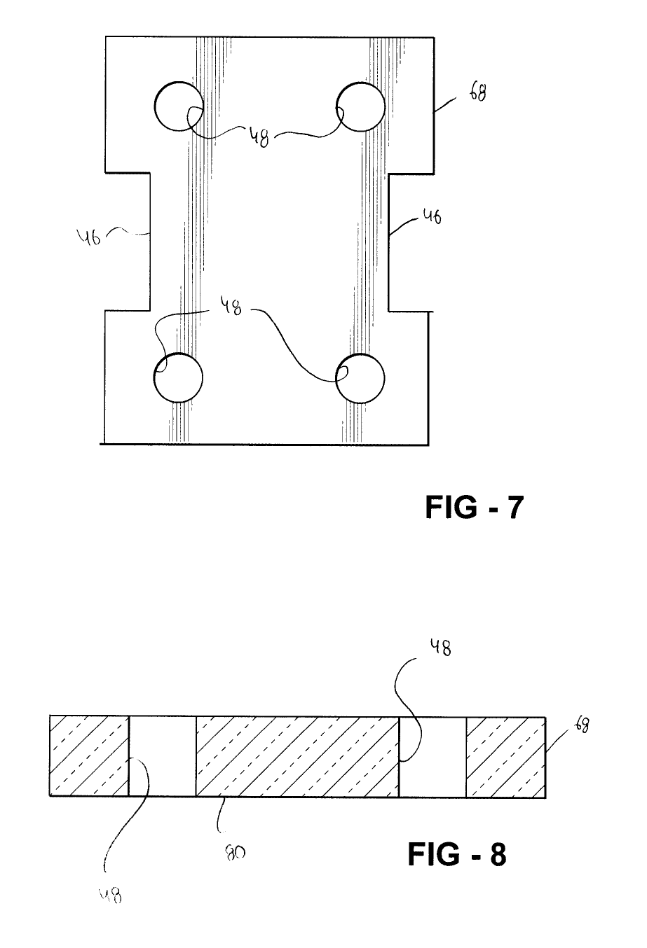

Referring to FIGS. 7 and 8, a support 68 is disposed adjacent the bottom surface of the support 68. The support 68 defines at least one ejector bore 48 therethrough. Preferably, and as shown in the Figures, the body 44 defines four ejector bores 48 therethrough, with the ejector bores 48 of the support 68 concentric with the ejector bores 48 defined by the body 44. The support 68 includes a generally rectangular shape having a pair of laterally space longitudinal sides and a pair of laterally spaced end walls. The support 68 defines a recess 46 in each of the longitudinal sides of the support 68, identical in size and shape and disposed adjacent the recesses 46 defined by the longitudinal sides of the body 44. It should be understood, with reference to the Figures, that the heads 62 of the ejector pins rest on and are sandwiched between the body 44 and the support 68, thereby securing the alignment pins 60 in position.

Preferably, the alignment pins 60 are press fit into the alignment bores 50 defined by the body 44. However, it should be understood that the alignment pins 60 may be attached to the body 44 by other methods, such as a set screw, tangent pin, glue, or some other method known to those skilled in the art.

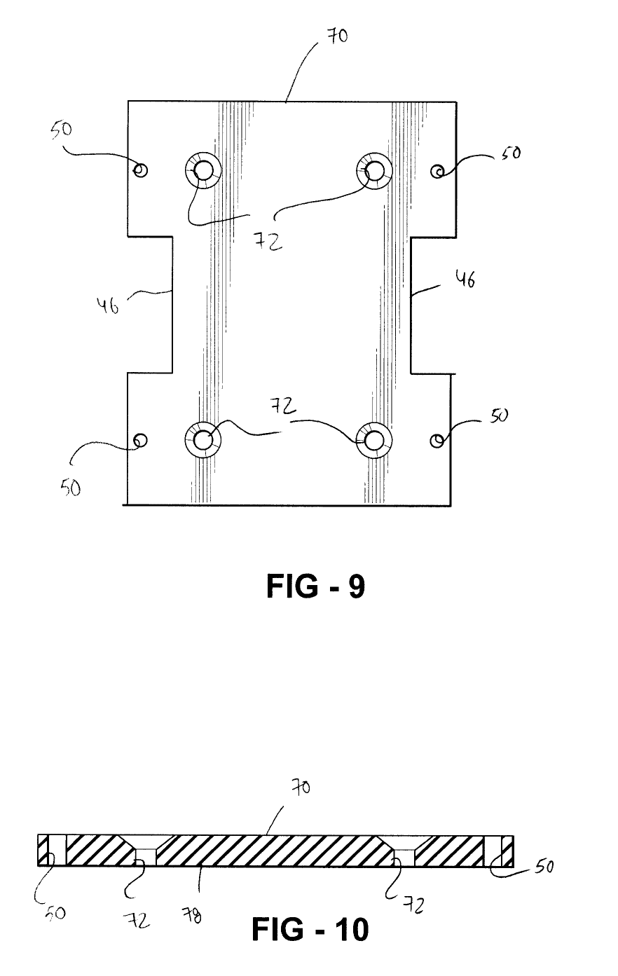

Referring to FIGS. 9 and 10, a cover plate 70 is disposed adjacent the top surface of the body 58. The cover plate 70 includes a generally rectangular shape having a pair of laterally spaced longitudinal sides and a pair of laterally spaced end walls. The cover plate 70 also defines a recess 46 in each of the longitudinal sides identical in size and shape and disposed over the recesses 46 defined by the body 44 and the support 68. The cover plate 70 defines at least two alignment bores 50 concentric with the alignment bores 50 defined by the body 44. The alignment bores 50 defined by the cover plate 70 include a diameter equal to the diameter of the shank portion 52 of the alignment bore 50 defined by the body 44. The cover plate 70 further defines a fastener passage 72 corresponding to each of the ejector bores 48 defined by the body 44 and the support 68. Preferably, and as shown in the Figures, the cover plate 70 defines four fastener passages 72 therethrough. Each of the fastener passages 72 is countersunk on a top surface of the cover plate 74.

Referring to FIGS. 2 and 3, an ejector shaft 76 is disposed in each of the ejector bores 48, and extends from a bottom surface of the cover plate 78 to near a bottom surface of the support 80. A fastener 82, such as a screw 82, is disposed within each of the fastener passages 72 and is in threaded engagement with the ejector shaft 76, thereby connecting the ejector shafts 76 to the cover plate 70. A head 62 of each of the fasteners is disposed within the countersunk portion of the fastener passage 72, below the top surface of the cover plate 74, to not interfere with movement of the several component layers 24 of the battery cell 10 over the top surface of the cover plate 74. The subject invention also provides a method of manufacturing the multi-layered battery cell 10.

Referring to FIG. 3, the method includes placing the several component layers 24 on the alignment device 20. Accordingly, the first insulator 36 layer is placed on the top surface of the cover plate 74, with the alignment apertures 42 positioned over the alignment pins 60. Likewise, the first electrode 26 layer is positioned over the first insulator 36 layer, the separator layer 34 is placed over the first electrode 26 layer, the second electrode 30 layer is placed over the separator layer 34, and the second insulator 38 layer is placed over the second electrode 30. The first current collector 28 is placed along one longitudinal side of the alignment device 20, over the second insulator 38 layer, and the second current collector 32 is placed along the other longitudinal side of the alignment device 20, over the second insulator 38 layer. Just as described for the first insulator 36 layer, the alignment apertures 42 defined by the first electrode 26, the separator layer 34, the second electrode 30, the second isolator layer, the first current collector 28 and the second current collector 32 are positioned over the alignment pin 60, with the alignment pin 60 extending through the several component layers 24 of the battery cell 10. In so doing, each of the several component layers 24 are properly aligned relative to each other. The several different component layers 24 are then attached together.

Preferably, and as is known in the art, the several different component layers 24 are attached by welding. After the several component layers 24 are assembled, i.e., attached together, an actuator (not shown) pushes upward on the ejector shafts 76 to raise the top cover and the assembled component layers 24 disposed thereon above the alignment pins 60. The assembled component layers 24 are then removed from the alignment device 20 for further manufacturing processes at other work stations. It is contemplated that at least one robotic arm (not shown) may be employed for moving the several different component layers 24 into position on the alignment device 20, and for moving the assembled component layers 24 from the alignment device 20 to the other manufacturing processes.

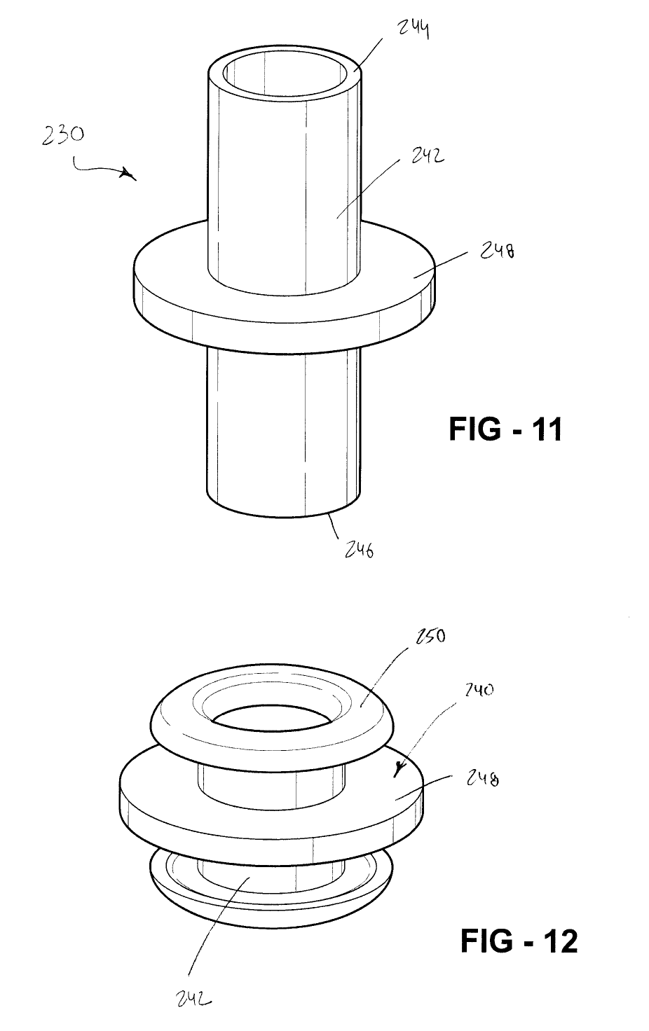

Referring to the FIGS. 11 through 14, another aspect of the present invention is shown. As best illustrated in FIGS. 13 and 14, each battery cell 10 includes an envelope or shell, generally indicated at 200 formed from a sheet of packaging material, such as aluminum. Those skilled in the lithium battery art will appreciate that the shell 200 may also be fabricated from any other suitable materials without limiting functional characteristics of the present invention. The shell 200 includes an upper wall 202 and a lower wall 204 defining a pocket 206 therebetween and extending over the first and second electrodes thereby encapsulating the first and second conductors with the shell 200 terminating into a negative terminal, defined by a lip 208 and a positive terminal (not shown) defined by another lip opposed the negative terminal with each of the positive and negative 208 terminals defining at least one contact with each of the negative and positive terminals.

Each of the contacts is provided for each polar contact to divide the current carrying capacity and to provide auxiliary paths for current flow in the event that one or more contacts would develop high resistance or electrically open. Each contact is further defined by an aperture or opening 210 defined in each terminal lip 208 transversely extending through the upper wall 202 and the lower wall 204. A pair first and second insulators 212 and 214 extend outwardly from the opposed openings 210 to define terminal ends 218 and 220, respectively.

A conductor device, generally shown at 230, formed from a copper or any other electrically conductive material, extends through each of the openings 210. A stud or the tie rod 234 extends through each opening 210 at each of the terminal lips 208 and is secured by a nut 236. As further illustrated in FIGS. 13 and 14, the device 230 is disposed between the first and second insulators 212 and 214 at the positive and negative terminals to define a boss or rivet, generally indicated at 240, around and above each of the openings 210.

FIG. 11 illustrates the device 230 in a non-folded stage and FIGS. 12 through 14 illustrate the device 230 in a folded stage. As best shown in FIG. 11, the device 230 is further defined by a tube 242 having terminal ends 244 and 246 and a radial lip 248 integral with and extending outwardly from tube 242. The terminal ends 246 and 248 are folded over the openings 210 and over the terminal ends 218 and 220 of the first and second insulators 212 and 214 to define a contact surface 250 that may include a concave configuration, as shown in FIGS. 13 and 14, or a rectangular configuration, as shown in FIG. 12, to provide improved “surface-to-surface” contact.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cell having at least first electrode and at least one second electrode of charge opposite from said first electrode and a separator layer positioned between the first and second electrodes; said lithium cell comprising:
a shell having an upper wall and a lower wall defining extending over the first and second insulators thereby encapsulating the first and second electrodes;
a first insulator and a second insulator extending over the first electrode and the second insulator extending over the second electrode; and
a conductor device disposed between said first and second insulators and extending through each of said upper wall and said lower wall to define a boss around and above each of said first insulator and said second insulator.

2. A cell for a battery pack as set forth in claim 1 wherein said conductor device is further defined by at least one tube each having terminal ends and a radial lip integral with and extending outwardly from said tube.

3. A cell for a battery pack as set forth in claim 2 wherein said terminal ends are folded to define a contact surface of the conductor device.

4. A cell for a battery pack as set forth in claim 1 wherein said conductor device is further defined by a plate having a plurality of tubes integral with and extending transversely therethrough and spaced one from another at a predetermined distance to complement with said openings.

5. A cell for a battery pack as set forth in claim 4 wherein said plate presents a rectangular configuration.

6. A cell for a battery pack as set forth in claim 2 wherein conductor device is further defined by a wire interconnecting said tubes spaced one from another at a predetermined distance to complement with said openings.

7. A cell for a battery pack as set forth in claim 1 wherein said conductor device is formed from copper.

8. A cell for a battery pack as set forth in claim 7 wherein said conductor device is a rivet.

9. A device for forming a layered battery cell having at least first electrode and at least one second electrode of charge opposite from said first electrode and a separator layer positioned between the first and second electrodes and at least one of a first current collector connected to at least one of the first and second electrodes and at least one of a second current collector connected to at least one of the first and second electrodes; said device comprising:
an assembly line for receiving and moving the first and second electrodes and the first and second current collectors,
at least one support member integrated with said assembly line, said at least one member having a plurality of pins extending therefrom for receiving the first and second electrodes and the first and second current collectors layered with one another; and
a sliding member supporting the first and second electrodes and the first and second current collectors, said sliding member being movable axially and along said pins to eject the first and second electrodes and the first and second current collectors assembled to a unitary package.

10. A device as set forth in claim 9 including an actuator connected to said sliding member for moving said sliding member relative said at least one support member.

11. A device as set forth in claim 10 including a base member connected to said at least one support member with said sliding member extending through said base member.

12. A device as set forth in claim 10 wherein said sliding member includes a plurality of slots to receive said pins.

13. A device as set forth in claim 10 including at least one robotic device adaptable for multi-axial movement for placing the first and second electrodes and the first and second current collectors is predetermined fashion onto said sliding device.
